(19) United States
(12) Patent Application Publication
(10) Pub. No.: US 2022/0113151 A1
(43) Pub. Date: Apr. 14, 2022

(54) MULTI-LEVEL PEDESTRIAN TRAVEL GENERATION SYSTEMS AND METHODS

(71) Applicant: Ford Global Technologies, LLC, Dearborn, MI (US)

(72) Inventors: Aed M. Dudar, Canton, MI (US); Finn Finn Tseng, Ann Arbor, MI (US); Bhagyashri Satyabodha Katti, Novi, MI (US)

(73) Assignee: Ford Global Technologies, LLC, Dearborn, MI (US)

(21) Appl. No.: 17/065,893

(22) Filed: Oct. 8, 2020

(51) Int. Cl. G01C 21/34; G06N 20/00

(52) U.S. Cl. CPC G01C 21/3461; G06N 20/00; G01C 21/343; G01C 21/3484

(57) ABSTRACT

Example embodiments described herein are generally directed to a navigation system that generates a pedestrian travel path based on various types of data stored in a database, such as, for example, a map, a blueprint, a historical record, a public record, and/or a personal record. In an example embodiment, the data may be obtained by executing a crowdsourcing procedure, where multiple individuals provide various types of information such as, information about an underground walkway, an elevated walkway, an unpaved pedestrian path, weather conditions, handicap-friendly pathways, and handicap-friendly structures. In an example application, a navigation device receives a navigation request that includes a start spot and an end spot for a pedestrian trip. The navigation device evaluates data stored in a database and uses the data to generate a pedestrian travel path that may include an underground walkway, an elevated walkway, an unpaved pedestrian path, and/or an enclosed pedestrian path.

### BACKGROUND

Global positioning system (GPS) navigation aids are employed ubiquitously in vehicles. GPS navigation aids are also employed by pedestrians. Pedestrian-oriented GPS systems are used by a variety of pedestrians, including hikers in remote areas and urbanites in cities. For example, an urbanite may opt to use a taxi service or a ride share service, such as Uber® or Lyft®, to reach a place close to a desired destination and then walk the “last mile” to reach the destination with the aid of a GPS system.

The phrase “last mile” generally refers to a relatively short distance that must be traversed as a final leg of a journey. For example, the last mile can refer to a walking distance from a subway station to an office building or a residence. In some cases, the last mile can be a final leg of a journey through an unfamiliar area, such as may be encountered by a tourist in a foreign country. As such, the last mile can pose various types of challenges, including a lack of knowledge of an area, lack of appropriate transport, road conditions (e.g., icy/slippery road or desolate roads) and/or encountering route changes due to road work, construction, or a traffic accident. These challenges may be compounded when an individual, such as a mother carrying an infant, or a tourist hauling a suitcase, has to traverse the last mile to reach his/her destination.

The hiker walking through unfamiliar territory or the urbanite walking the last mile may find the use of a GPS device very convenient. However, the GPS device typically relies on visual data obtained from satellite photographs or ground-based cameras. Such data may not include alternative walking routes that are preferable in some ways, such as, for example, one that offers a shortcut, one that offers protection from the elements (sun, rain, etc.), or one that is customized to the needs of a handicapped individual.

It is therefore desirable to provide systems and methods that address such shortcomings in traditional navigation systems.

### BRIEF DESCRIPTION OF THE DRAWINGS

A detailed description is set forth below with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 shows an example scenario in which a navigation device is employed in accordance with an embodiment of the disclosure.

FIG. 2 shows an example navigation system in accordance with an embodiment of the disclosure.

FIG. 3 shows another example scenario in which a navigation device is employed in accordance with an embodiment of the disclosure.

FIG. 4 shows yet another example scenario in which a navigation device is employed in accordance with an embodiment of the disclosure.

FIG. 5 shows some components that may be included in an example navigation device in accordance with an embodiment of the disclosure.

FIG. 6 shows some components that may be included in another example navigation device in accordance with an embodiment of the disclosure.

### DETAILED DESCRIPTION

### Overview

In terms of a general overview, certain embodiments described in this disclosure are directed to a navigation system that generates a pedestrian travel path based on various types of data stored in a database, such as, for example, a map, a blueprint, a historical record, a public record, and/or a personal record. Data stored in the database may also include data used by conventional GPS navigation systems such as, for example, GPS coordinates and topography details. In some instances, certain types of data may be obtained by executing a crowdsourcing procedure, where multiple individuals provide various types of information, such as, for example, information/images about an underground walkway, an elevated walkway, an unpaved pedestrian path, weather conditions, handicap-friendly pathways, and handicap-friendly structures. In an example application, a navigation device receives a navigation request that includes a start spot and an end spot for a pedestrian trip. The navigation device selects and evaluates data stored in various databases and uses the data to generate a pedestrian travel path that may include an underground walkway, an elevated walkway, an unpaved pedestrian path, and/or an enclosed pedestrian path.

### Illustrative Embodiments

The disclosure will be described more fully hereinafter with reference to the accompanying drawings, in which example embodiments of the disclosure are shown. This disclosure may, however, be embodied in many different forms and should not be construed as limited to the example embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described example embodiments but should be defined only in accordance with the following claims and their equivalents. The description below has been presented for the purposes of illustration and is not intended to be exhaustive or to be limited to the precise form disclosed. It should be understood that alternate implementations may be used in any combination desired to form additional hybrid implementations of the present disclosure. For example, any of the functionality described with respect to a particular device or component may be performed by another device or component. Furthermore, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

Certain words and phrases are used herein solely for convenience and such words and terms should be interpreted as referring to various objects and actions that are generally understood in various forms and equivalencies by persons of ordinary skill in the art. For example, the word “data” as used herein refers to any kind of input or information that can be received and operated upon by a processor of a computer system, such as for example, GPS coordinates, a rendering of a map, a representation of a building, a digital photograph, a digital image, or an electronic copy of a document. Various words such as “identifying,” “evaluating,” “generating” and “determining” as used herein are examples of operations that may be performed by a processor upon various types of data. Words such as “wireless” or “wirelessly” as used herein in the context of communication links are not intended to preclude other forms of communication links such as optical communication links and wired communication links that may be used alternatively. Furthermore, it should be understood that the word “example” as used herein is intended to be non-exclusionary and non-limiting in nature.

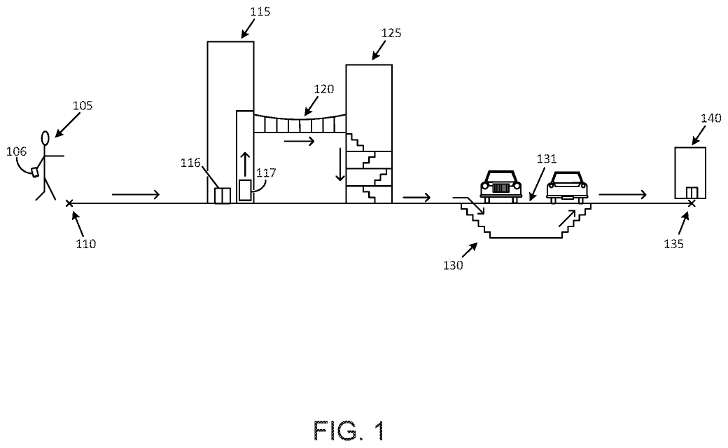

FIG. 1 shows an example scenario in which a navigation device 106 is employed in accordance with an embodiment of the disclosure. In this example scenario, the navigation device 106 is a handheld device such as a cellular phone, a table, or a phablet (phone plus tablet) that may be used by a pedestrian 105 to request and obtain navigation assistance to travel from a start spot 110 to an end spot 135. The start spot 110 can be any location such as, for example, a sidewalk. The end spot 135 can be, for example, an entrance to a building 140. The pedestrian 105 may also include in the request, additional information such as handicap access requirements (ramp, for example), weather preferences (avoiding prolonged exposure to sunlight, allergies to pollen, etc.), personal medical conditions, and personal physical conditions (cannot climb stairs, fear of heights, etc.).

Upon receiving the request, the navigation device 106 may access a database to obtain various types of information. The information may include items such as, for example, a map, a blueprint, a historical record, a public record, and/or a personal record. The information may also include data such as, for example, GPS coordinates and topography details that are used by conventional GPS navigation systems. In this example case, the navigation device 106 may obtain information used by a conventional GPS navigation system and either edit, modify, supplement, or replace that information with information such as, for example, a blueprint of a building 115, a blueprint of a building 125, a blueprint of an elevated walkway 120 between an upper story of the building 115 and an upper story of the building 125, and a blueprint of an underground walkway 130. The underground walkway 130, which may be a part of a tunnel may offer a safe path for pedestrians to use when crossing a road 131 above the underground walkway 130. The road 131 may, for example, be used by high-speed road traffic.

The navigation device 106 may also use information obtained via crowdsourcing a number of people. The information can include, for example, a user preference for using the elevated walkway 120 and/or the underground walkway 130 in place of following a travel path recommended by a conventional GPS navigation system. The travel path recommended by the conventional GPS system may include walking around the building 115, walking around the building 125, and crossing the road 131 over the underground walkway 130. In some cases, walking around the building 115 and/or the building 125 may be undesirable for reasons such as, for example, due to poor weather conditions (hot sun or rain, for example), increased walking distance, and bad sidewalks. Crossing the road 131 may be hazardous due to the high-speed road traffic. A typical conventional GPS navigation system may not take into consideration such factors when offering navigation assistance.

The navigation device 106 may generate a pedestrian travel path that is a multi-level travel path involving walking on the elevated walkway 120 and walking through the underground walkway 130. In one example case, the navigation device 106 may generate the pedestrian travel path by combining information used by conventional GPS navigation system with information obtained in accordance with the disclosure (map, blueprint, historical records, crowdsourcing etc.). In another example case, the navigation device 106 may generate the pedestrian travel path by exclusively using information obtained in accordance with the disclosure (map, blueprint, historical records, crowdsourcing etc.).

The navigation device 106 may also provide step-by-step navigation guidance to the pedestrian 105 based on the generated pedestrian travel path. The step-by-step navigation guidance can be provided in various ways, such as by audible instructions, visual guidance, or a combination of audible instructions and visual guidance. In one example implementation, the navigation device 106 is a smartphone and the pedestrian 105 may make a request for navigation assistance by using a graphical user interface (GUI) displayed on a display screen of the smartphone. The smartphone may display navigation graphics such as, for example, a map or a line indicating a walking route, and provide step-by-step navigation guidance based on the generated pedestrian travel path.

A first step of the step-by-step guidance directs the pedestrian 105 to walk towards the building 115. The second step may direct the pedestrian 105 to enter the building via an entrance 116. The third step may guide the pedestrian 105 inside the building 115 towards an elevator 117 and instruct the pedestrian 105 to use the elevator 117 to travel to an upper story (fourth story, for example). Guiding the pedestrian 105 inside the building 115 may be based, in one example case, on information obtained via crowdsourcing, and in another example case, based on documentation of the building 115 stored in a public repository.

The fourth step may guide the pedestrian 105 through the elevated walkway 120 and into the building 125. The fifth step may instruct the pedestrian 105 to go down to the first floor of the building 125. The building 125 may not have an elevator. Consequently, the pedestrian 105 may walk down a stairwell inside the building 125. Guiding the pedestrian 105 inside the building 115 may be based, in one example case, on information obtained via crowdsourcing or through documentation accessible to the navigation device 106. Guidance provided to the pedestrian 105 may further include information such as, for example, a number of floors to be walked, a number of steps in one or more stairways in the stairwell, and signs on doors and passageways.

The sixth step may instruct the pedestrian 105 to use the underground walkway 130 to cross the road 131. Providing this instruction may be based on, for example, documentation stored in a repository, input provided by the pedestrian 105 (heavy traffic, for example), and/or via crowdsourcing. Information obtained from the various sources can include, for example, a user preference among crowdsourcing participants regarding use of the underground walkway 130 at certain times of the day (traffic density, safety concerns during walking across the road 131, safety concerns associated with walking through the underground walkway 130, etc.), and handicap-friendly facilities that may, or may not, be available at the underground walkway 130. The seventh step may provide guidance for the pedestrian 105 to walk from the exit of the underground walkway 130 to the entrance of the building 140.

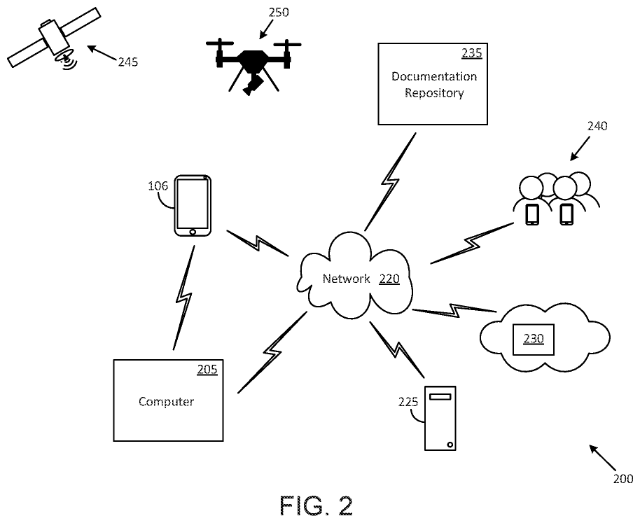

FIG. 2 shows an example navigation system 200 in accordance with an embodiment of the disclosure. The navigation system 200 can include one or more navigation devices such as the navigation device 106 and a computer 205 that is configured to perform some operations in accordance with the disclosure. The navigation device 106 and the computer 205 are communicatively coupled via a network 220 to various elements such as, for example, a server 225, a cloud storage element 230, a documentation repository 235, and various devices (smartphones, for example) that provide crowdsourcing information from a number of people who constitute a crowdsource 240.

The network 220 may include any one, or a combination of networks, such as a local area network (LAN), a wide area network (WAN), a telephone network, a cellular network, a cable network, a wireless network, and/or private/public networks such as the Internet. For example, the network 220 may support communication technologies such as cellular, near-field communication (NFC), Bluetooth®, Wi-Fi, Wi-Fi direct, machine-to-machine communication, and/or man-to-machine communication. The communication links between the network 220 and the various devices are shown as wireless links in FIG. 2. It must be understood though that the communication links can be implemented using various forms of media (wired, wireless, optical etc.) and various communication protocols.

Elements such as the server 225, the cloud storage element 230, the documentation repository 235, and the crowdsource 240 are configured to provide to the navigation device 106 and/or the computer 205, various types of data for generating a pedestrian travel path in accordance with the disclosure. Such data may be used by the navigation device 106 and/or the computer 205 to complement or supplement data stored locally in the navigation device 106 and/or the computer 205. Data may also be obtained by navigation device 106 and/or the computer 205 from a GPS satellite 245 (GPS coordinates, topographic images, etc.,) and from an unmanned aerial vehicle (UAV) 250 (localized weather information, cartographic information, etc.). Operations associated with the UAV 250 will be described below using another figure.

In an example scenario, the navigation device 106 and/or the computer 205 may receive a navigation request from the pedestrian 105 and respond to the request by generating a pedestrian travel path. The pedestrian travel path may be generated in the manner described above, using information stored in a local database of the navigation device 106 and/or the computer 205 and/or from various sources such as the server 225, the cloud storage element 230, the documentation repository 235, and the crowdsource 240. Information may also be received from the GPS satellite 245 (GPS coordinates, topographic images, etc.,) and/or the UAV 250 (localized weather information, cartographic information, etc.).

In some cases, a pedestrian travel path generated by navigation device 106 and/or the computer 205 can be a multi-level pedestrian travel path that involves the pedestrian 105 walking above ground (elevated walkway 120, for example) and/or below ground (underground walkway 130, for example). In some other cases, a pedestrian travel path generated by navigation device 106 and/or the computer 205 can be a ground-level pedestrian travel path that is generated in accordance with the disclosure. The ground-level pedestrian travel path may be preferred when the pedestrian 105 is physically challenged and is unable to use structures such as the elevated walkway 120 and the underground walkway 130.

The documentation repository 235 can include computers located in one or more places such as, for example, a library, a government records office, a museum, a corporation, a university, or a research facility. The computers of the documentation repository 235 may be accessed by the navigation device 106 and/or the computer 205 to obtain items such as a map, a blueprint, a historical record, and/or a public record, that may be used to generate a pedestrian travel path in accordance with the disclosure.

Some examples of a map that may be accessed and examined by the navigation device 106 and/or the computer 205 is a local area map, a campus map (a map of the premises of the building 115, for example), and a tourist map that shows walkways. Such maps may not necessarily be targeted for use by motorists, who typically seek information about roads and driving-related facilities (gas stations, for example).

Some examples of a blueprint include an architectural blueprint of the building 125 and an architectural blueprint of the underground walkway 130. Such blueprints provide information such as, for example, the number of steps in a stairway and availability of a wheelchair ramp. One example of a historical record is a blueprint of an underground rail tunnel that is no longer in use. One example of a public record is a blueprint of the road 131.

The server 225 and the cloud storage element 230 may also be used by the navigation device 106 and/or the computer 205 to obtain items such as those, for example, described above with respect to the documentation repository 235, and other items such as personal information pertaining to the pedestrian 105.

The crowdsource 240 can include multiple individuals that use various devices (phones, tablets, laptops, desktops, etc.) to provide various types of information to the navigation device 106 and/or the computer 205 such as, for example, information about an underground walkway, an elevated walkway, an unpaved pedestrian path, weather conditions, handicap-friendly pathways, and handicap-friendly structures. Other examples of information provided by the crowdsource 240 can include various types of scores, various types of ratings, accessibility, cleanliness, lighting, walkability, safety, handicap-friendliness, availability of toilets, and landmarks that can assist the pedestrian 105. Popular Machine Learning techniques, such as Collaborative Filtering and Cohort learning, can be used to on the data collected from various crowd source participants. Cohort learning helps to establish groups of individuals who are similar in their behavior and/or preferences for a particular last-mile. Within a cohort, data can be used to learn the patterns from other individuals who are similar to pedestrian 105, and this can be used to recommend appropriate/most relevant last mile to pedestrian 105. For example, a cohort can be made up of individuals who prefer/travel often by sidewalks/roads with ramps, since it enables easy use of strollers as they have children in toddler age group. By learning their preference for sidewalks/roads with ramps, the computer 205 can use data of such similar users that have travelled on this particular road/street before and suggest this as a relevant last mile recommendation to pedestrian 105. Further, computer 205 can use Machine Learning techniques to learn patterns/preferred roads from the pedestrian 105's travel data. This becomes a implicit data source and this supplemented with explicit setting/preferences given by 105 can be used by computer 205 to filter and rank last mile suggestions from a set of estimated last mile options.

A processor in the navigation device 106 may generate the pedestrian travel path and also provide step-by-step navigation instructions to the pedestrian 105 as described above. The step-by-step instructions may be provided in the form of audible instructions and/or as visual guidance via a display screen of the navigation device 106. The computer 205, which can be a desktop computer or a laptop computer, for example, can generate the pedestrian travel path in accordance with the disclosure and wirelessly communicate the pedestrian travel path to the navigation device 106 for use by the pedestrian 105.

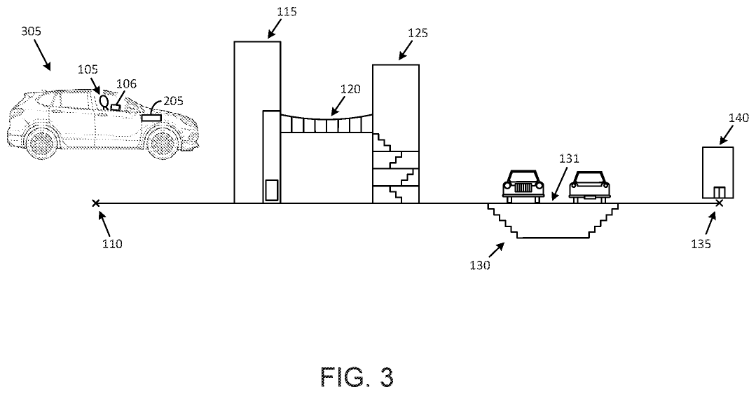

FIG. 3 shows another example scenario in which the navigation device 106 may be employed in accordance with an embodiment of the disclosure. In this example scenario, the pedestrian 105 is seated in a vehicle 305 at the start spot 110. The vehicle 305 may be any of various types of vehicles such as a gasoline powered vehicle, an electric vehicle, a hybrid electric vehicle, or an autonomous vehicle. The vehicle 305 can be a private vehicle that is owned or leased by the pedestrian 105 or can be a commercial vehicle such as a taxi or a vehicle operated by a ride share service such as Uber® or Lyft®. In the example scenario depicted in FIG. 3, the pedestrian 105 is seated in a ride share vehicle driven by a driver (not shown) of a ride share service.

The vehicle 305 is stopped at a drop-off location close to the start spot 110 described above. In this case, a trip from the start spot 110 to the end spot 135 constitutes a last mile travel for the pedestrian 105. The pedestrian 105 is unfamiliar with the area and desires to obtain information that will help him reach the end spot 135. In one example situation, the pedestrian 105 may seek the assistance of the driver.

The driver may decide that it is not easy to provide oral directions, and may therefore decide to use the computer 205 in the vehicle 305 in order to generate a pedestrian travel path. The generated pedestrian travel path and any additional information may then be downloaded from the computer 205 into a smartphone (navigation device 106) of the pedestrian 105. The portable smartphone can then be used by the pedestrian 105 to obtain step-by-step navigation guidance as the pedestrian 105 moves towards the end spot 135.

In another example situation, the pedestrian 105 may have a smartphone that already includes navigation software. Consequently, the pedestrian 105 may enter a navigation request into the smartphone rather than seek help from the driver. The smartphone may generate a pedestrian travel path for use by the pedestrian 105 to travel to the end spot 135.

The computer 205 in the vehicle 305 can be an independent computer or may be a part of a vehicle computer that performs various functions such as controlling engine operations (fuel injection, speed control, emissions control, braking, etc.), managing climate controls (air conditioning, heating etc.), and issuing warnings (check engine light, bulb failure, low tire pressure, vehicle in blind spot, etc.). In one example implementation, the computer 205 may be configured to operate in accordance with the disclosure by providing suitable software for this purpose. The software may be provided in the computer 205 by various entities, such as, for example a manufacturer (during manufacture of the vehicle 305), a sales agency selling the vehicle 305 after manufacture, or a purchaser of the vehicle 305.

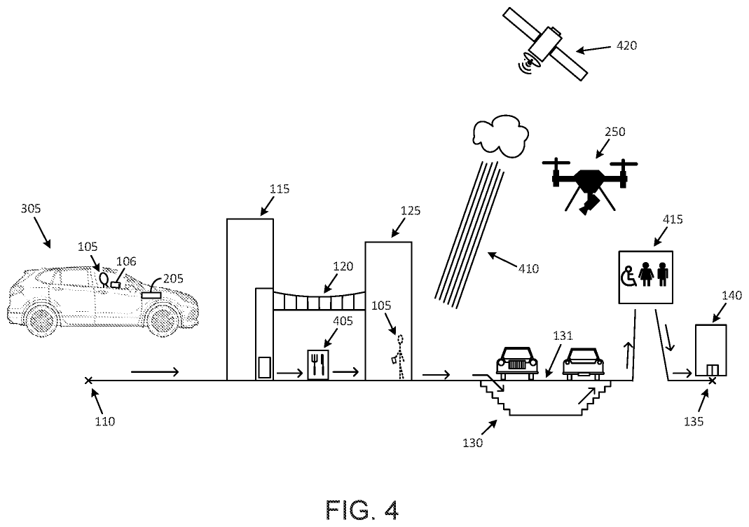

FIG. 4 shows yet another example scenario in which the navigation device 106 can be employed by the pedestrian 105 in accordance with an embodiment of the disclosure. The pedestrian 105 may have arrived at the start spot 110 in the vehicle 305 as described above. In this example scenario, the computer 205 and/or the navigation device 106 may generate a pedestrian travel path taking into consideration various factors in addition to, or in lieu of, structural factors. Some example of such other factors may include weather, time, and availability of facilities. Some examples of structural factors can include the elevated walkway 120, the underground walkway 130, an enclosed pedestrian path (inside the building 125, for example), and/or an unpaved pedestrian path (around the building 115 on a gravel path, for example).

The weather factor may be taken into consideration by the navigation device 106 and/or the computer 205 by using information pertaining to weather at one or more locations between the start spot 110 and the end spot 135. The information may be obtained by the navigation device 106 and/or the computer 205 from various sources.

In one example implementation, crowdsourcing may be employed for this purpose. The crowdsourcing may, for example, involve a first person providing information to the navigation device 106 and/or the computer 205 of a rain shower 410 outside the building 125, a second person providing information regarding a traffic jam on the road 131 due to the rain shower 410 or an accident, a third person providing information regarding a failure of the elevator inside the building 115, and so on.

In another example implementation, weather information may be obtained by the navigation device 106 and/or the computer 205 from a weather forecasting source (local weather service, national weather service, etc.

In yet another example implementation, weather information may be obtained by the navigation device 106 and/or the computer 205 by using the UAV 250 and/or a weather satellite 420. For example, the navigation device 106 and/or the computer 205 may wirelessly communicate with the UAV 250 to arrange for the UAV 250 to fly between the start spot 110 and the end spot 135, or to fly to certain locations between the start spot 110 and the end spot 135, to scout out weather conditions. The data transmitted by the UAV 250 to the navigation device 106 and/or the computer 205 provides information that may be used to generate a pedestrian travel path and provide weather-based and time-based guidance to the pedestrian 105. For example, the step-by-step guidance provided by the navigation device 106 may advice the pedestrian, ahead of time, of the weather conditions along the pedestrian travel path and inform/recommend a wait period inside the building 125 until the rain shower 410 stopped.

In another example, the navigation device 106 may recommend a delayed start from the start spot 110 so as to avoid encountering the rain shower 410 and/or to avoid the scene of a traffic accident. In yet another example, the navigation device 106 and/or the computer 205 may modify the pedestrian travel path based on the weather conditions and other conditions. The modification can include, for example, re-routing the pedestrian 105 around the area where the rain shower 410 is occurring.

In some implementations, the navigation device 106 and/or the computer 205 may generate a pedestrian travel path based on the availability of various types of facilities between the start spot 110 and the end spot 135. The pedestrian 105 may request a certain type of facility that he/she wishes to visit while walking from the start spot 110 to the end spot 135. The request may be a part of the input provided to the navigation device 106 and/or the computer 205 prior to proceeding from the start spot 110 to the end spot 135 or may be provided during the walk from the start spot 110 to the end spot 135. The navigation device 106 and/or the computer 205 may update or revise a pedestrian travel path when a request is made by the pedestrian 105 at some location in between the start spot 110 and the end spot 135.

One example request made by the pedestrian 105 may pertain to obtaining food. The navigation device 106 and/or the computer 205 may respond to the request by generating, updating, or revising a pedestrian travel path to include a restaurant 405 located between the start spot 110 and the end spot 135. Another example request made by the pedestrian 105 may pertain to using a toilet. The navigation device 106 and/or the computer 205 may respond to the request by generating, updating, or revising a pedestrian travel path to include a detour to a public restroom 415 between the start spot 110 and the end spot 135. The request made by the pedestrian 105 may further specify that the toilet must have a handicapped stall.

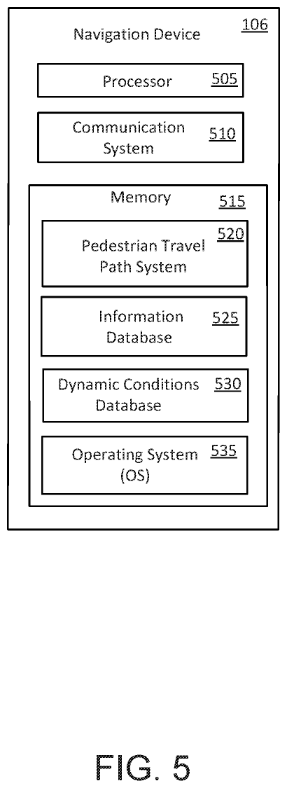

FIG. 5 shows some components that may be included in the navigation device 106 in accordance with an embodiment of the disclosure. The navigation device 106 may include a processor 505, a communication system 510, and a memory 515. The communication system 510 can include a wireless transceiver that allows the navigation device 106 to communicate with various devices such as the computer 205, the UAV 250, and devices coupled to the network 220. The communication system 510 can also include circuitry to receive signals from the GPS satellite 245 and the weather satellite 420.

The memory 515, which is one example of a non-transitory computer-readable medium, may be used to store an operating system (OS) 535, and code modules such as a pedestrian travel path system 520. The memory 515 can also store other content such as an information database 525 and a dynamic conditions database 530. The code modules stored in the memory 515 are provided in the form of computer-executable instructions that can be executed by the processor 505 for performing various operations in accordance with the disclosure. In one implementation in accordance with the disclosure, where the navigation device 106 is a smartphone, the pedestrian travel path system 520 code module may be a software application that is downloaded from an app store such as Google Play® or installed in the smartphone by an entity such as a manufacturer or a seller of the smartphone.

The pedestrian travel path system 520 code module may be executed by the processor 505 for performing operations such as generating a pedestrian travel path and for providing step-by-step guidance to the pedestrian 105 when walking from the start spot 110 to the end spot 135. Generating a pedestrian travel path can include operations such as obtaining information from various sources. Some information may be available in the navigation device 106 such as, for example, personal information about the pedestrian 105 (medical history, allergies, preferences, etc.) that may be stored in the information database 525. When the information is not available locally, the navigation device 106 can obtain information by communicating via the network 220 with various devices such as the documentation repository 235, the cloud storage element 230, and the server 225 and/or from the crowdsource 240. Information received from such sources may be stored in the information database 525. Dynamic information such as, for example, weather or traffic conditions can be obtained from sources such as the UAV 250 or the crowdsource 240 and stored in the dynamic conditions database 530. The information stored in the dynamic conditions database 530 can be dynamically updated on a periodic basis, intermittent basis, or as-needed basis.

In one example implementation, the pedestrian travel path system 520 code module may be executed by the processor 505 for generating a pedestrian travel path that includes labels. The labels, which can be a part of a graphic displayed on a GUI of the navigation device 106, may provide information about various objects that may be helpful to the pedestrian 105. For example, a label may be associated with the underground walkway 130 and displayed on the GUI next to an entry to the underground walkway 130. The label may indicate the number of steps in a stairway of the underground walkway 130.

Another label may be associated with the building 115 (for example) and displayed on the GUI next to an entry to the building 115. The label may indicate an elevation level of the elevated walkway 120 and may further indicate location coordinates (GPS coordinates, for example) of the building 115 where the elevated walkway 120 is located.

Yet another label may be associated with the building 125 (for example) and displayed on the GUI next to an entry to the building 125. The label may indicate a number of floors that the pedestrian 105 has to walk down to reach street level. Yet another label may indicate rules, regulations, and availability of facilities inside a building.

In another example implementation, the pedestrian travel path system 520 code module may be executed by the processor 505 for generating a pedestrian travel path that includes icons that may be displayed on a GUI of the navigation device 106. The pedestrian 105 may activate an icon (for example, touch the icon on a touchscreen of the navigation device 106) to obtain various types of information. For example, activating a first icon may cause the navigation device 106 to display a map of an interior portion of the building 115. The pedestrian 105 can use the map to reach the elevator 117 or to go to a restaurant inside the building 115. The pedestrian 105 may activate another icon to obtain information about the rain shower 410, for example, before reaching the building 125 and may use the information to wait out the rain shower 410 at the restaurant 405 rather than inside the building 125.

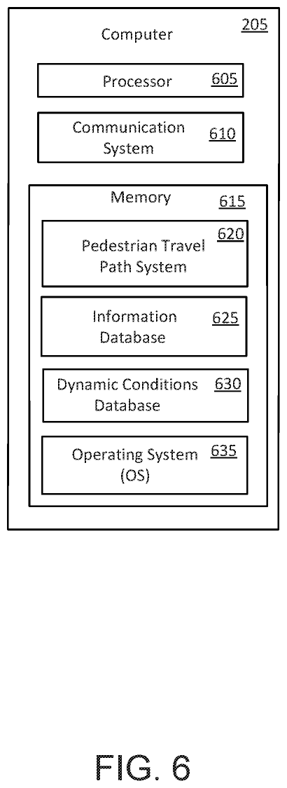

FIG. 6 shows some components that may be included in the computer 205 in accordance with an embodiment of the disclosure. The computer 205 may include a processor 605, a communication system 610, and a memory 615. The communication system 610 can include a wireless transceiver that allows the computer 205 to communicate with various devices such as the navigation device 106, the UAV 250, and devices coupled to the network 220. The communication system 510 can also include circuitry to receive signals from the GPS satellite 245 and the weather satellite 420. When the computer 205 is a part of the vehicle 305, the communication system 610 can incorporate various types of wireless media and communication formats such as, for example, a vehicle-to-everything (V2X) communication format, an Internet communications format, or a cellular communications format.

The memory 615, which is another example of a non-transitory computer-readable medium, may be used to store an operating system (OS) 635, and code modules such as a pedestrian travel path system 620. The code modules are provided in the form of computer-executable instructions that can be executed by the processor 605 for performing various operations in accordance with the disclosure. The memory 615 can also store other content such as an information database 625 and a dynamic conditions database 630.

The pedestrian travel path system 620 code module may be executed by the processor 605 for performing operations such as generating a pedestrian travel path. The pedestrian travel path may be wirelessly communicated to the navigation device 106 for use by the pedestrian 105. In some cases, the pedestrian travel path system 620 code module may be executed by the processor 605 for generating step-by-step guidance to the pedestrian 105. This guidance may also be transferred to the navigation device 106. The information database 625 and the dynamic conditions database 630 can be used in a manner similar to that described above with respect to the information database 525 and the dynamic conditions database 530.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize one or more devices that include hardware, such as, for example, one or more processors and system memory, as discussed herein. An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of non-transitory computer-readable media.

Computer-executable instructions comprise, for example, instructions and data which, when executed at a processor, cause the processor to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

A memory device such as the memory 515 and the memory 615, can include any one memory element or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, the memory device may incorporate electronic, magnetic, optical, and/or other types of storage media. In the context of this document, a “non-transitory computer-readable medium” can be, for example but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random-access memory (RAM) (electronic), a read-only memory (ROM) (electronic), an erasable programmable read-only memory (EPROM, EEPROM, or Flash memory) (electronic), and a portable compact disc read-only memory (CD ROM) (optical). Note that the computer-readable medium could even be paper or another suitable medium upon which the program is printed, since the program can be electronically captured, for instance, via optical scanning of the paper or other medium, then compiled, interpreted or otherwise processed in a suitable manner if necessary, and then stored in a computer memory.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein for purposes of illustration and are not intended to be limiting. Embodiments of the present disclosure may be implemented in further types of devices, as would be known to persons skilled in the relevant art(s).

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described example embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method comprising:
receiving, by a navigation device, an input for a pedestrian trip, the input comprising a start spot and an end spot for the pedestrian trip;
identifying, by the navigation device, an underground walkway and/or an elevated walkway located between the start spot and the end spot; and
generating, by the navigation device, a pedestrian travel path that includes the underground walkway and/or the elevated walkway.

2. The method of claim 1, wherein the input further comprises a map, an image, and/or a blueprint, and wherein identifying the underground walkway and/or the elevated walkway between the start spot and the end spot comprises examining the map, the image, and/or the blueprint.

3. The method of claim 1, wherein identifying the underground walkway and/or the elevated walkway between the start spot and the end spot comprises executing a crowdsourcing procedure including Machine Learning techniques.

4. The method of claim 3, wherein executing the crowdsourcing procedure comprises:
determining a level of user preference for use of the underground walkway and/or the elevated walkway; and
including the underground walkway and/or the elevated walkway in the pedestrian travel path based on the level of user preference.

5. The method of claim 1, wherein identifying the underground walkway and/or the elevated walkway between the start spot and the end spot comprises examining historical records of the individual user as well of other crowdsource participating users who are similar in their last mile preferences/choices and last mile traversing habits/behaviors

6. The method of claim 1, wherein the underground walkway comprises a tunnel and the elevated walkway extends from a first building to a second building.

7. The method of claim 1, further comprising:
identifying, by the navigation device, based on the input, a structural characteristic of the underground walkway; and
including, by the navigation device, in the pedestrian travel path, a first label that indicates the structural characteristic of the underground walkway.

8. The method of claim 1, further comprising:
identifying by the navigation device, based on the input, a number of steps in a stairway of the underground walkway; and
including, in the pedestrian travel path, a label that indicates the number of steps in the stairway.

9. A method comprising:
generating, by a navigation device and based on an input, a pedestrian travel path that includes an underground walkway;
identifying, by the navigation device and based on the input, a physical characteristic of the underground walkway; and
including, by the navigation device, in the pedestrian travel path, a first label that indicates the physical characteristic of the underground walkway.

10. The method of claim 9, wherein identifying the physical characteristic of the underground walkway comprises identifying a number of steps in a stairway of the underground walkway, and wherein the first label indicates the number of steps in the stairway.

11. The method of claim 9, wherein the pedestrian travel path further includes an elevated walkway between a first building and a second building, and the method further comprises:
identifying an elevation level of the elevated walkway; and
including, in the pedestrian travel path, a second label that indicates the elevation level of the elevated walkway.

12. The method of claim 11, further comprising:
identifying a set of location coordinates for a first location in the elevated walkway; and
including, in the second label, the set of location coordinates for the first location in the elevated walkway.

13. The method of claim 9, further comprising:
executing a crowdsourcing procedure to identify a rating and/or a score associated with the underground walkway from other users who are similar in their last mile preferences and traversing habits

14. The method of claim 9, wherein generating the pedestrian travel path comprises examining a map, an image, a blueprint, and/or a historical record.

15. A navigation device comprising:
a memory that stores computer-executable instructions; and
a processor configured to access the memory and execute the computer-executable instructions to:
receive an input for a pedestrian trip, the input comprising a start spot and an end spot for the pedestrian trip;
identify an underground walkway and/or an elevated walkway located between the start spot and the end spot for the pedestrian trip; and
generate a pedestrian travel path that includes the underground walkway and/or the elevated walkway.

16. The navigation device of claim 15, wherein the processor is further configured to access the memory and execute additional computer-executable instructions to at least:
evaluate a map, an image, a blueprint, and/or a historical record to identify the underground walkway and/or the elevated walkway between the start spot and the end spot for the pedestrian trip.

17. The navigation device of claim 15, wherein the processor is further configured to access the memory and execute additional computer-executable instructions to at least:
execute a crowdsourcing procedure to identify the underground walkway and/or the elevated walkway between the start spot and the end spot for the pedestrian trip.

18. The navigation device of claim 17, wherein the processor is further configured to access the memory and execute additional computer-executable instructions to at least:
determining a level of user preference for use of the underground walkway and/or the elevated walkway; and
including the underground walkway and/or the elevated walkway in the pedestrian travel path based on the level of user preference.

19. The navigation device of claim 17, wherein the processor is further configured to access the memory and execute additional computer-executable instructions to at least:
identify a set of location coordinates for a first location in the elevated walkway;
identify an elevation level of the elevated walkway at the first location; and
include, in the pedestrian travel path, a label that indicates the set of location coordinates and the elevation level.

20. The navigation device of claim 17, wherein the processor is further configured to access the memory and execute additional computer-executable instructions to at least:
identify a number of steps in a stairway of the underground walkway; and
include, in the pedestrian travel path, a label that indicates the number of steps in the stairway.
